(19) United States
(12) Patent Application Publication
(10) Pub. No.: US 2012/0049509 A1
(43) Pub. Date: Mar. 1, 2012

(54) SECONDARY CONTAINED CSST PIPE AND FITTING ASSEMBLY

(76) Inventors: Thomas B. Lininger, Mantua, OH (US); Steven M. Powell, Chardon, OH (US); Nicholas Novak, Willowick, OH (US)

(21) Appl. No.: 12/064,539

(22) PCT Filed: Aug. 22, 2006
(86) PCT No.: PCT/US06/32627

§ 371 Date: Feb. 5, 2009

Related U.S. Application Data
(60) Provisional application No. 60/710,261, filed on Aug. 22, 2005.

(51) Int. Cl. F16L 39/00; F16L 25/00; F16L 9/18; F16L 9/06

(52) U.S. Cl. 285/93; 285/123.1; 138/114

(57) ABSTRACT

A double wall pipe assembly includes an inner primary pipe (4) and an outer secondary pipe (5), as well as a novel fitting assembly (3) for terminating the double wall pipe assembly. The primary pipe is a flexible annularly corrugated pipe made from stainless steel which is flexible and nearly impermeable to fuels. The fitting assembly provides an integrated seal of the secondary pipe to a fastener (8) used to seal the primary pipe to fitting body. The fitting assembly may also maintain communication between an interstitial space between the primary and secondary pipes and an access port (182) in the fastener. The access port can be used for monitoring of the interstitial space between the primary and secondary pipe.

### RELATED APPLICATIONS

The present application claims the benefit of the filing date of U.S. Provisional Application No. 60/710,261, filed Aug. 22, 2005, the disclosure of which is incorporated herein by reference.

### FIELD OF THE INVENTION

The invention herein described relates generally to secondarily contained pipes and fittings and more particularly to secondarily contained annularly corrugated steel tube pipes and fittings useful, in particular, for the underground transport of hydrocarbon fuels and solvents.

### BACKGROUND OF THE INVENTION

Secondary containment pipes (also termed “coaxial”) are typically used in fuel station installations where a primary pipe is the main supply between an underground storage tank and the pump and the secondary pipe surrounds the primary pipe along the length thereof and is terminated at a sump or a fluid detection sensor. Secondary containment pipes are used to contain unintentional fluid release from the primary pipe. Typically an “interstitial space” is provided between the primary and secondary pipes to allow any released fuel to flow to a containment sump or to a sensor.

All thermoplastic containment pipes for fuel delivery applications have been used for many years by companies like OPW Fueling Components (U.S. Pat. No. 5,098,221) and Environ Products (U.S. Pat. Nos. 5,263,794 and 5,297,896). In some pipe assemblies, internal ribs have been employed to space the containment pipe from the primary pipe, such as is shown in U.S. Pat. No. 5,611,373. Brugg Rohrsysteme in Germany makes a primary and secondary fuel pipe assembly with a flexible, helically corrugated stainless steel (CSST) primary pipe and an outer thermoplastic containment pipe that is separated from the primary pipe by various means (European Patent Publication Nos. 0890768A2, 0890768B1, 0890769A2, and 1219882A2). The Brugg Rohrsysteme uses bitumen (graphite) to effect a seal between the primary pipe and the associated fitting.

Annularly corrugated, as well as spirally corrugated, metal tubing, often fabricated of stainless steel or copper and jacketed with a plastic material, is commonly employed in residential or commercial building constructions as a transitional fluid conduit extending between an appliance or other machine and a rigid auxiliary line, pipe, or other connection of a fuel source which may be natural gas, propane, or the like. The flexibility of such tubing facilitates the alignment of couplings and other connections, and also accommodates limited movement of the appliance or machine with respect to the rigid connection of the fuel source.

Recently, tubing of such type, and particularly corrugated stainless steel tubing, has been employed as a substitute for traditional hard, i.e., inflexible, steel or iron “black” pipe in gas line applications for residential and commercial construction. Advantageously, the flexibility of the tubing facilitates its installation through walls, ceilings, and floors and, especially, the alignment of the tubing connections. Moreover, such tubing is lightweight, easy to carry, requires no threading or heavy equipment therefor, allows the use of fewer fitting connections, and exhibits less leak potential than conventional, hard piping. Corrugated tubing additionally is used in other fluid transport applications such as in air conditioning, hydraulics, and general plumbing, and also as conduit for electrical applications. Tubing manufacturers include the Parflex Division of Parker-Hannifin Corp., Ravenna, Ohio, Titeflex Corp. of Springfield, Mass., OmegaFlex, Inc. of Exton, Pa., and Wardflex Manufacturing of Blossburg, Pa.

Compression and other fitting connections are commonly used in natural gas line and other applications. As shown, for example, in commonly-assigned U.S. Pat. Nos. 6,036,237; 6,019,399; 6,428,052; 6,173,995; 6,079,749; 5,799,989; 5,441,312; 5,292,156; 5,226,682; 5,080,405; 4,904,002; 4,630,850; 4,674,775; 2,549,741; and 2,323,912, and in U.K. Patent No. 1,371,609, such connections typically involve a nut and an associated collet, split ring, ferrule, flare, C-ring or rings, bushing, sleeve, or other compression or locking member which is received in or over the tube end for holding the tube end within the nut as the nut is tightened onto a nipple, adapter, body or other connector.

As the use of corrugated tubing in gas line and other fluid transfer applications continues to increase, it will be appreciated that further improvements in the design of fitting connections therefor would be well-received. A preferred design would be economical to manufacture, but would also simplify the assembly of the coupling while providing a connection which minimizes the potential for leaks and the like. Also, applicants have appreciated it would be advantageous to extend the use of annularly corrugated tubes to secondarily contained pipe assemblies and particularly such assemblies suitable for underground transport of hydrocarbon fuels and solvents.

### SUMMARY OF THE INVENTION

The present invention provides a novel double wall pipe assembly including an inner primary pipe and an outer secondary pipe, as well as a novel fitting assembly for terminating the double wall pipe assembly. The primary pipe preferably is a flexible annularly corrugated pipe made from stainless steel which is flexible and nearly impermeable to fuels. The secondary pipe can be multilayer with yarn reinforcement for higher pressure capacity or improved flexibility. The secondary containment pipe can be annularly or helically corrugated for improved flexibility.

The fitting assembly provides a unique integrated seal of the secondary pipe to a fastener used to seal the primary pipe to fitting body. The fitting assembly may also maintain communication between an interstitial space between the primary and secondary pipes and an access port in the fastener. The access port can be used for monitoring of the interstitial space between the primary and secondary pipe. Also, a preferred fitting assembly enables quick “push-In and tighten” attachment of the pipe assembly to facilitate onsite assembly, as well as a reliable metal-to-metal seal of the primary pipe to a mating fitting body.

Accordingly, a flexible double wall pipe assembly comprises an inner primary pipe for conveying a fluid and an outer secondary pipe surrounding the primary pipe for containing any fluid leaks from the primary pipe. The inner primary pipe and outer secondary pipe define therebetween an interstitial space extending along the lengths thereof to allow any fluid released from the primary pipe to flow along the length of the interstitial space, and the inner primary pipe is a flexible annularly corrugated pipe having annular valley portions alternating with annular crest portions that define a major outer diameter of the pipe.

The corrugated pipe preferably is made of stainless steel, and the secondary pipe may be made of metal or a thermoplastic material, and further may be annularly or helically corrugated. The radially outwardly disposed annular crests of the corrugated pipe may have one or more axially extending recesses formed therein for providing increased flow area between the primary and secondary pipes at the regions of the radially outwardly disposed annular crests.

According to another aspect of the invention, the fitting assembly comprises a fitting body having a threaded end portion, and a fastener having a threaded portion for threadedly engaging the threaded portion of the fitting body and for securing the primary pipe to the fitting body. The fastener includes a tubular portion opposite its threaded portion, and the tubular portion is configured to receive an end portion of the outer secondary pipe. A coupling device is provided for securing the end portion of the outer secondary pipe in fluid tight relationship to the tubular portion of the fastener.

The coupling device may include one or more of a compression fitting, bonded joint, a push-to-connect mechanism, or a clamp.

In a preferred embodiment, the fastener includes an interior space for fluid communication with the interstitial space between the primary and secondary pipes, and an access port extending from the interior space to the exterior of the fastener. The access port may be a view port allowing visual viewing of the interior space from outside the fastener, or the access port may be configured for connection to a conduit for remote sensing or other purposes. The interior space may be at least partly defined by the fastener and the fitting body, and a seal may be interposed between the fastener and the fitting body to seal the interior space with respect to the outside.

Further features of the invention will become apparent from the following detailed description when considered in conjunction with the drawings.

### BRIEF DESCRIPTION OF THE DRAWINGS

An exemplary embodiment of the invention is illustrated in the accompanying drawings in which:

FIG. 1 is a cutaway, perspective view of an exemplary flexible double wall pipe assembly and associated fitting assembly in accordance with the present invention, with an inner primary corrugated pipe of the pipe assembly shown only partially inserted into a fitting assembly;

FIG. 2 is a part cross-sectional, part elevational view of the assemblies of FIG. 1;

FIG. 3 is view similar to FIG. 2, but showing the primary corrugated pipe substantially fully inserted into a fitting body that forms part of the fitting assembly;

FIG. 4 is an enlarged portion of FIG. 3;

FIG. 5 is a perspective view of a collet employed in the fitting assembly;

FIG. 6 is a part cross-sectional, part elevational view of the collet, taken along line 4-4 of FIG. 5;

FIG. 7 is a fragmentary, part cross-sectional, part elevational view showing the fitting assembly tightened to effect a seal between the primary corrugated pipe and the fitting body; and

FIG. 8 is a fragmentary cross-sectional view of the wall of the corrugated primary pipe, showing a recess formed in a crest thereof.

### DETAILED DESCRIPTION

Certain terminology may be employed in the following description for convenience rather than for any limiting purpose. For example, the terms “forward” and “rearward,” “front” and “rear,” “right” and “left, upper” and “lower,” “top” and “bottom,” and “right” and “left” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “vertical” and “axial” or “horizontal” referring, respectively, to directions, axes, or planes perpendicular and parallel to the longitudinal central axis of the referenced element, and the terms “downstream” and “upstream” referring, respectively, to directions in and opposite that of fluid flow. Terminology of similar import other than the words specifically mentioned above likewise is to be considered as being used in a relational sense for purposes of convenience.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

For the illustrative purposes of the discourse to follow, the precepts of the fitting connection for the flexible double wall pipe assembly involved are described in conjunction with a “straight” fitting and assembly therefor particularly adapted for underground transport of hydrocarbon fuels and solvents. It is to be appreciated, however, that the present invention may find utility in other connector configurations, such as adapters, unions, tees, elbows, and crosses, and as integrated or other port connections for valves, cylinders, manifolds, sensors, and other fluid components, as well as in other applications for flexible secondarily contained pipes. Use within these and other configurations and applications therefore should be considered to be expressly within the scope of the invention herein involved.

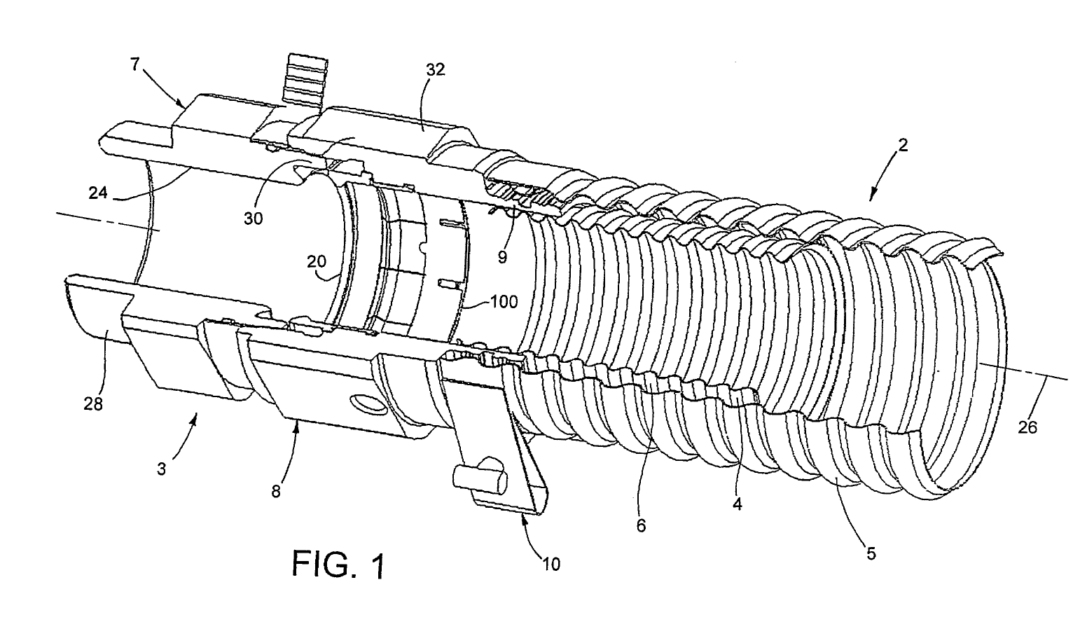

Referring now to the figures wherein corresponding reference characters are used to designate corresponding elements throughout the several views with equivalent elements being referenced with prime or sequential alphanumeric designations, an exemplary flexible double wall pipe assembly and associated fitting assembly according to the present invention are respectively designated by reference numerals 2 and 3 in FIG. 1. The flexible double wall pipe assembly includes a flexible inner primary pipe 4 for conveying a fluid and a flexible outer secondary pipe 5 surrounding the primary pipe (the term “pipe” is intended to encompass tube, tubing and the like). The secondary pipe 5 serves as a containment pipe for capturing any fluid leaks from the primary pipe within an interstitial space 6 formed between the pipes and extending along the lengths thereof to allow any fluid released from the primary pipe to flow along the length of the interstitial space. The fitting assembly 3 comprises a fitting body 7 having an exteriorly threaded end, and a fastener 8, such as a nut. The fastener 8 has an internally threaded portion for threadedly engaging the threaded portion of the fitting body and for securing the primary pipe to the fitting body. The fastener 8 further includes a tubular portion 9 opposite its internally threaded portion. The tubular portion 9 is configured to receive an end portion of the outer containment pipe, such end portion being secured in fluid type relationship to the fastener by a coupling device 10.

The primary pipe 4 preferably is a flexible annularly corrugated pipe that preferably is made of metal and particularly stainless steel. The preferred primary pipe has annular valley portions alternating with annular crest portions that define a major outer diameter of the pipe.

The secondary (or containment) pipe 5 may also be a flexible annularly corrugated pipe that may be made of metal such as stainless steel. Spirally corrugated pipe may be used, and the corrugated pipe may be formed from other materials such as a thermoplastic. In still further embodiments, non-corrugated flexible pipe may be used. Thermoplastic pipe may be made of a fuel resistant thermoplastic(s) such as polyamide, polytetrafluoroethylene, fluorinated-ethylene propylene, perfluoroalkoxy, polyvinyl alcohol, ethylene vinyl alcohol polyethylene, polyphenelyne sulfide, polyacetal copolymer, polyvinylidene fluoride, ethylene-tetrafluoroethylene, ethylene-fluorinated ethylene propylene or ethylene-chlorotrifluoro-ethylene. The pipe may be a bi-layer consisting of an inner liner material of a fuel resistant thermoplastic such as listed above with a lower cost, lower compatibility material used to form an outer layer of the pipe. The pipe alternatively may have a fuel resistant thermoplastic inner liner with a layer of aluminum strip, which is resistant to fuels, and an outer layer of thermoplastic, which may or may not be fuel resistant.

Primary Pipe-Fitting Connection

The fitting assembly 3 preferably is configured to terminate the primary pipe 4 in a manner similar to that described in U.S. Pat. No. 6,908,114, which is hereby incorporated herein by reference. Accordingly, the fitting assembly 3 further comprises a generally annular collet 20 which is receivable coaxially within the fastener 8 and the fitting body 7.

The illustrated exemplary fitting body 7 has a straight configuration, but could be of other configurations such as an elbow, tees, crosses, etc. The fitting body is generally tubular with an internal axial throughbore 24 extending coaxially with a central longitudinal axis 26. By way of convention, axial directions along axis 26, which for purposes of convenience will be used as a common reference axis for each of the components of the illustrated fitting assembly 3, will be referred to as “forward,” “forwardly,” or “front” if in the direction of or towards or adjacent a body forward end portion 28, and as “rearward,” “rearwardly,” or “rear” if in the opposite direction of or towards or adjacent the body rearward end portion 30.

The forward end portion 28 of the fitting body 7 may be suitably configured for connection to a further component, although it will be appreciated that the fitting body may itself be formed integrally in another component. For example, the end portion 28 may be threaded for a male threaded pipe connection, and the outer surface of the fitting body may be provided wrenching surfaces such as flats 32 arranged in a hexagonal pattern for engagement by a wrench or other tool during make-up or disassembly of the fitting connection. The forward end portion 28 alternatively may be configured instead for a female threaded pipe connection, or for a tube, welded or other connection.

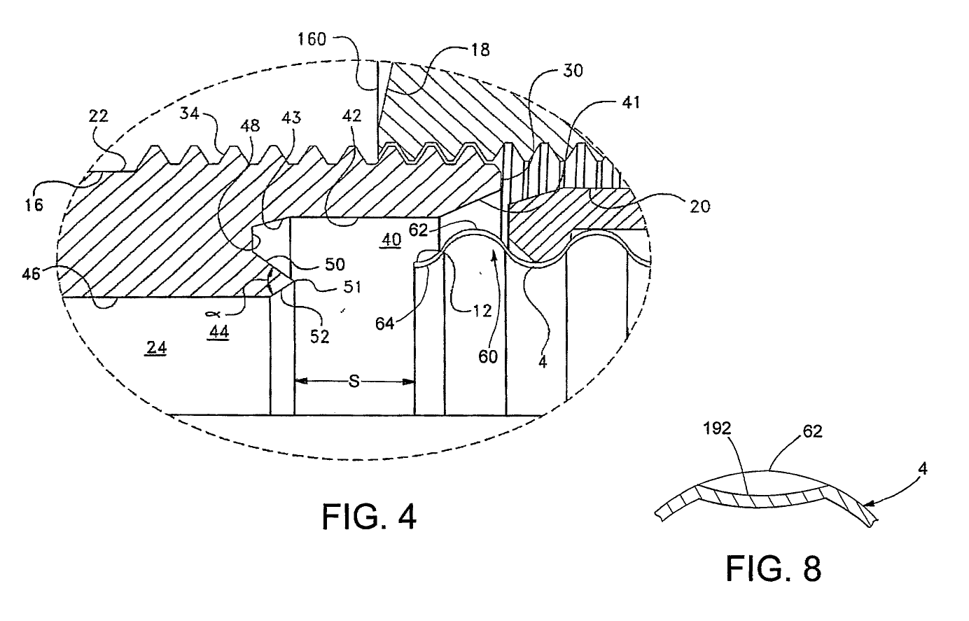

The rearward end portion 30 of the fitting body 7 is externally threaded as shown at 34 in FIG. 4.

As further shown in FIG. 4, the fitting body bore 24 is counterbored beginning from the opening of the body rearward end and ending intermediate the rearward end and the opening of the forward end of the fitting so as to define a larger diameter rearward end portion or socket 40 having a rearwardly-facing, lead-in chamfer 41 and an inner circumferential surface 42 which may transition to a rearward taper 43 and a smaller diameter forward end portion 44 having an inner circumferential surface 46 which, as is shown, may be generally cylindrical. The rearward end portion 40 terminates at a generally upstanding, annular end wall 48 which adjoins the taper 43 and which, in turn, extends radially inwardly in transitioning to a rearwardly-facing, tapered sealing or seating surface 50 which may have a generally annular, frustoconical geometry in being inclined or angled in the forward axial direction along axis 26. The sealing surface 50 itself may transition by way of a rounded or radiused apex 51 to a chamfer 52, so as to define an inside angle α, which may be acute, but which alternatively may be obtuse. Other configurations of the sealing surface may also be used if desired.

The opening at the body rearward end 30 is sized to accept the distal end 12 of the primary pipe 4 for insertion into the fitting body 7. The primary pipe 4 is conventionally formed of a series of sinusoidal corrugations, a first one of which is referenced at 60. These corrugations define valleys or valley portions 64 alternating with crests or crest portions 62. The valleys define a minor outer diameter of the primary pipe and the crests define the outer periphery, i.e., major outer diameter, of the primary pipe. As is shown at 66, distal end 12 of pipe 4 is formed by cutting through, preferably centrally, of the first one of the valleys 64, which also herein referred to as a root or trough portions.

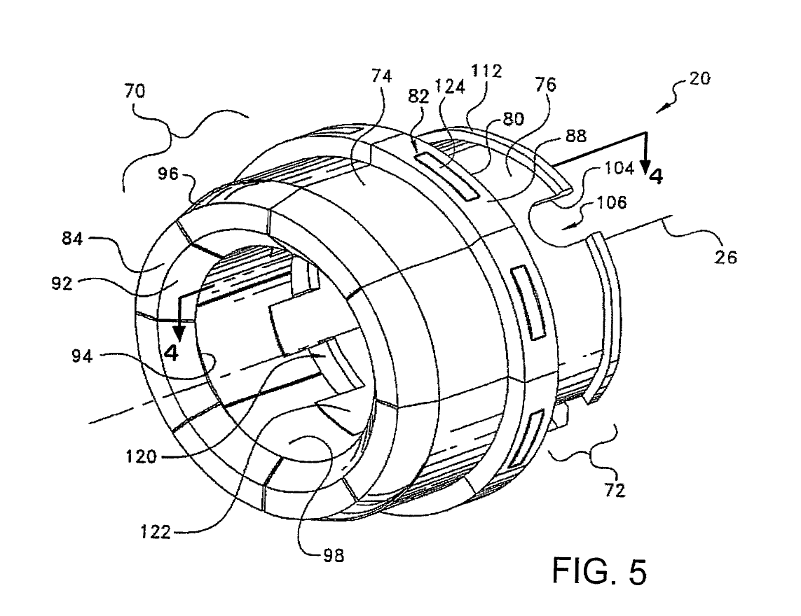

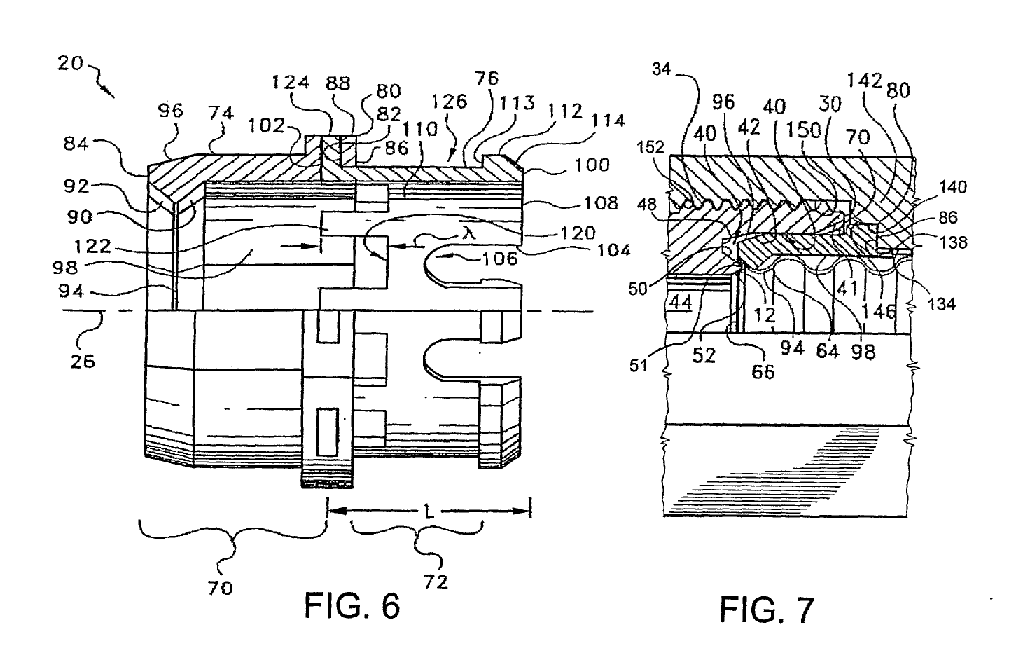

Referring now to FIGS. 5 and 6, the collet 20 in the illustrated embodiment is formed as a composite of a forward portion, referenced at 70, and a rearward portion, referenced at 72. The collet forward portion 70 is constructed of a number of individual, arcuate tangs, one of which is referenced at 74, arranged in a series circumferentially about axis 26, with the collet rearward portion 72 being constructed as a generally annular, flexible retaining collar 76, which resiliently retains the individual tangs 74 of the forward portion 70 in their circumferential arrangement about axis 26.

As arranged in such series, each of the tangs 74 may be generally abutting or adjoining, i.e., the sides thereof are not separated by substantial spaces therebetween, and define a major inner diametric extent of the collet forward portion 70 which may be incrementally larger than the major outer diameter of the primary pipe 4 (FIGS. 1-3), so as to allow the primary pipe distal end 12 to be received coaxially therethrough. In the illustrated embodiment, each of the eight tangs 74 which are shown is of an about equal radial extent which usually would be preferred. The number of tang segments comprising the collet forward portion 70 may vary as generally depending upon the nominal diameter of collet 20, but typically will be at least two and may be eight as shown, or more, or any number therebetween.

Each of the arcuate tangs 74 forming the collet forward portion 70 may extend from a rearward end 80, which may be configured, as shown, as a generally upstanding flange, having a slot 82 therethrough, to a forward end 84. The slot 82 may have a generally L-shaped axial cross-section in extending from the backside 86 of the rearward end 80, through to the topside 88 of the end 80. The slot 82 may extend through the topside 88 and may have a generally wedged-shaped radial cross-section.

At the forward end 84, tang 74 may be configured as having rearwardly-facing angled surface 90 and an adjoining forwardly-facing angled surface 92. At truncated, flattened, radiused, or other vertex thereof the surfaces 90 and 92 define a radially inwardly-extending, generally conical tooth or other gripping or retaining portion 94, receivable within a pipe root portion 64 (FIG. 4). In the circumferential arrangement of the tangs 74 about the axis 26, the surfaces 92, which may be generally parallel to the body sealing surface 50 in the assembled connection, may form in the normal, unexpanded or closed orientation of the collet 20, a circular, generally conical or frustoconical, annular ring about the axis 26. The ring 95 defines a minor inner diametric extent of the collet forward portion 70 which may approximate or be incrementally larger than the primary pipe minor outer diameter, but otherwise smaller than the primary pipe major outer diameter, such that, when received within one of the pipe root portion 64, the tang retaining portions 94 hold the primary pipe 4 and thereby delimit the axial movement thereof relative to the collet 20. Advantageously, the shape of such ring, which may be generally non-collapsing due to the abutment between the side of each of the tangs with the corresponding side of each adjacent tang, need not deviate substantially from circularity, and in that regard may function as a solid ring to help more reliably seal the pipe end against the body sealing surface.

The forward end 84 of each of the tangs 74 further may be configured as having an outer chamfered surface 96, which may form a leading edge of the collet 20. Each of the collet tangs 74 have an extent, referenced at λ in FIG. 7, which may be selected to extend over, for example, two or more pipe corrugations. Together with the extents of the other tangs 74, theses extents define a circumferential wall portion, referenced at 98 in FIG. 5, of the collet 20 which, in turn, defines the major inner diametric extent of the collet forward portion 70. Each of the tangs 74, which may be formed of a metal such as brass, may be machined, molded, cast, sintered such as by powdered metallurgy, or, preferably, metal injection molded for more precise dimensional tolerance, or otherwise formed.

The collar 76 forming the collet rearward portion 72 may be molded, stamped, machined or otherwise formed of a plastic or, alternatively, of another material such a metal, and is provided to allow for the resilient expansion of the collet forward portion 70 such that the primary pipe 4 may received coaxially therethrough. In that regard, the collar 76 may have an inner diametric extent which generally matches the major inner diametric extent of the collet forward portion 70 so as to provide a generally smooth transition therebetween, and which further may be only incrementally larger than the pipe major outer diameter to guide and support the primary pipe 4 as the distal end 12 thereof is being inserted into the fitting.

The collar 76 extends along an axial length, referenced at “L” in FIG. 6, from a rearward end 100 to a forward end 102. Such length, as with the tang length λ (FIG. 6), may be selected to extend over, for example, two or more pipe corrugations, and defines a circumferential wall portion of the collar 76.

The collar rearward end 100 may be configured, as shown, as being divided into a series of rearward segments, one of which is referenced at 104, by a corresponding series of notches or other rebates, one of which is referenced at 106. Each of the segments 104, which thereby afford the collar rearward end 100 a degree of resiliency, i.e., to be expanded or collapsed, may have a distal end 108 and a proximal end 110, and may be formed at the distal end 108 as a shoulder 112, having a forward surface 113, and a tapered, rearward surface 114. As is shown, the shoulder 112 may extend generally continuously about axis 26 intermediate between the rebates 106, although it should be appreciated that the shoulder 112 instead may be interrupted or otherwise discontinuous about the axis 26 between the rebates 106.

At the forward end 102, collar 76 may be “crenellated,” or otherwise notched, indented, or rebated, one of which is referenced at 120, so as to again form a series of forward segments, one of which is referenced at 122, which may correspond in number to the number of tangs 74. Each of the segments 122 may have a generally L-shaped cross-section, and as joined to a corresponding one of the collet forward portion tangs 74, functions as a “living hinge” for biasing the collet forward portion in its normally closed orientation, while allowing for the resilient expansion or opening of the collet forward portion 70 from such orientation to an expanded or open orientation enlarging the minor inner diametric extent such that the major outer diameter of the primary pipe 4 is receivable therethrough. An upstanding portion 124 of each of the forward segments 122 may be molded into, interference or snap fit, bonded, or otherwise joined within a slot 82 of a corresponding one of the tangs 74. As assembled, the forward surface 113 of the collar rearward end 100 is axially spaced-apart as at 126 from the backside surface 86 of the tang rearward ends 80.

Depending upon such factors as the stiffness of the material of construction for the collar 76 and the degree of resiliency or flexibility desired in the expansion of the collet forward portion 70, the depth of the rebates 120 and, accordingly, the effective length, referenced at λ in FIG. 4, of the segments 122, may be adjust to achieve the desired response. By adjusting length of the depth of the rebates 120 and the length of the collar segments 122, differing degrees of flexibility may be achieved for the opening of the tangs 74 in the expansion of the collet forward portion 70.

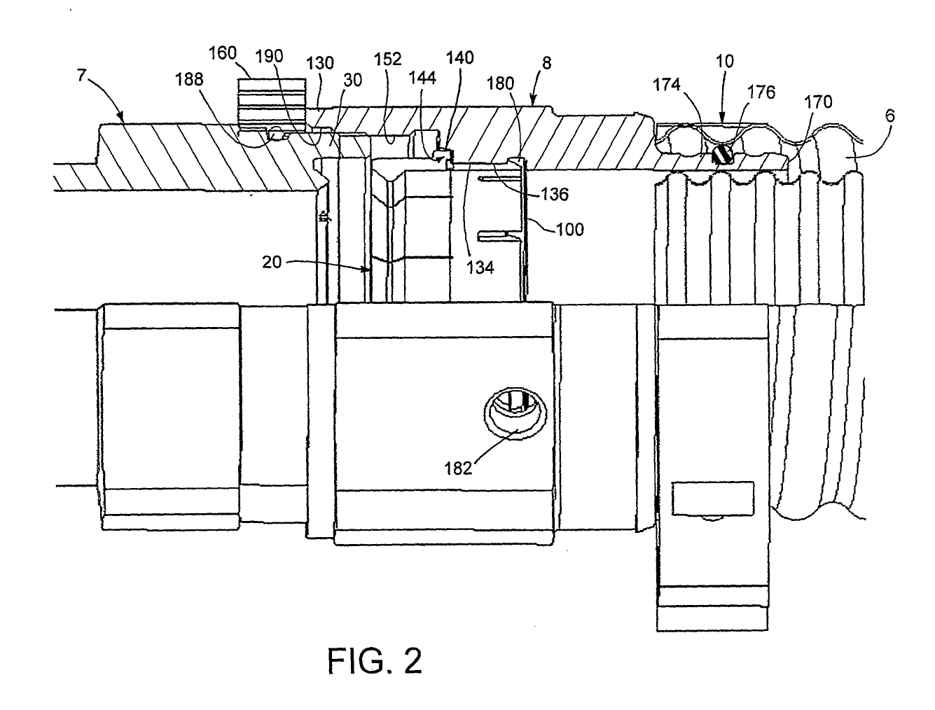

Returning to FIGS. 1 and 2, the fastener 8 in the illustrated embodiment is configured generally as a hexagonal, cap-type nut which may be formed of the same or different metal or other material as the body 7. The fastener 8 is journaled coaxially over the collar rearward end 100, and is seated on the collet 20, such as in the space between a collar forward surface 113 and the tang backside surfaces 86 for a removable, threaded engagement with the fitting body rearward end portion 30. The fastener 8 thus extends from an open forward end to a rearward end, which includes a radially inwardly-projecting, primary shoulder portion 134 having an opening 136, which is sized to retain the fastener 8 in the space between the collet surfaces 113 and 86, while allowing for primary pipe to be received concentrically through the opening 136 and the collet 20. The opening 136 may be sized to be incrementally larger than the outer diameter of the collet collar 76 in the space 126 so as to provide support therefor as the pipe end is inserted, and to assist in keeping the collet and pipe centered within the connection.

The primary shoulder portion 134 defines a forwardly-facing, generally annular end wall which, together with an adjoining lateral wall 140, of an adjacent, internal secondary shoulder portion, defines an internal pocket 144, which is sized to receive the flanged rearward end 80 of the tangs 74. A forwardly-facing, lead-in chamfer may be provided on the secondary shoulder portion to help guide the tang ends 80 into the pocket 144 during the make-up of the connection 10. During make-up, the seating of the collet tangs 74 within the pocket 144 assists in keeping the collet tangs closed and seated within the pipe corrugation.

The fastener 8 at its forward end portion 130 is internally threaded at 152 for threadably engaging the external threads 34 on the rearward end portion 30 of the fitting body. The inner diameter of the threaded end portion of the fastener 8 is sized to provide a clearance with the collet 20 to accommodate the radial outward expansion of the collet tangs 74 as the pipe end 12 is inserted therethrough.

Prior to the insertion of the primary pipe end and/or the partial threading of the fastener 8 onto the fitting body for the “pre-assembly” of the connection 10, the fastener 8 and collet 20 may be themselves be pre-assembled such as by inserting the collar rearward end 100 through the fastener opening 136, with the engagement of the collar rearward surface 114 with the opening 136 causing a camming action effecting the resilient collapse of the diameter of the collar rearward end 100, such as may be accommodated through the rebates 106 (FIG. 5), allowing the end 100 to be received through the fastener opening 136. Thereafter, the fastener 8 may be partially threaded onto the body rearward end 30 with the collar rearward end 100 extending rearwardly externally of the fastener 8, and with the fastener 8 being slidably movable intermediate the collet surfaces 113 and 86.

Although optional, it may be preferred for ease of use and to assure proper depth insertion of the primary tube, that a positive spacing is provided controlling the distance that the fastener 8 is partially threaded onto the body end 30. Such spacing, as is shown in FIGS. 1 and 2, may be provided by a tear-away plastic ring or other spacer 160, which may be interposed between the forward end of the fastener and the radially enlarged wrenching portion of the fitting body. The spacer may be torn-away or otherwise removed prior to the torquing of the fastener 8. As is shown, such spacer 160 may be sized to axially position the fastener 8 relative to the body sealing surface 50 such that, upon the insertion of the primary pipe and the seating of the tang retaining portions 94 within the first pipe root 64, the axial distance, referenced at “s” in FIG. 4, between the sealing surface 50 and the pipe distal end 12 is less than is necessary to further advance the pipe past the second corrugation thereof before the engagement of the pipe end 12 against the sealing surface 50. Alternatively, the spacer 160 may be sized such that a positive stop is established by the abutting engagement of the pipe end 12 against the sealing surface 50 upon the collet tangs retaining portions 94 being received within the first pipe root 64. A conventional thread locking material also may be substituted, such material being coated onto the body threads 34 as applied either from the forwardmost and extending rearwardly to a point defining the forward position of the fastener 8 such that the fastener is threaded, such as by hand, onto the uncoated threads with additional torquing requiring a wrench or other tool. The locking material alternatively may be applied to the threads beginning from the rearwardmost and extending forwardly to a point define the forward position of the fastener 8 such that the fastener is threaded onto the coated portion of the threads and is “locked” thereon with additional torquing again requiring a wrench to break the lock. Visual inspection and/or tactile or audible, i.e., a “snap,” feedback also may be used to confirm the tube has been inserted the proper amount into the fitting assembly.

In FIG. 2, the fitting assembly is shown pre-assembled for receipt of the primary pipe. For the make-up of the connection, the end of the primary pipe 4 may be inserted coaxially though the collet collar rearward end 100 and the fastener opening 136 effecting the expansion or opening of the tangs 74 of the collet forward portion 70 by the camming action developed by the bearing of the tang surface 90 on the first pipe corrugation 60, with the forward advancement of the collet being delimited by the abutting engagement of the collar surface 113 against the fastener shoulder 134. Upon the forward advancement of the crest portion 62 of the first corrugation 60 past the tang retaining portions 94, the tangs 74 resiliently return to their normal, unexpanded state with the retaining portion 94 being receiving within the pipe root 64 as is shown in FIG. 4. Thereupon, the make-up of the primary pipe to fitting connection may be completed by the tearing-away or other removal of the spacer 160, and the tightening of the fastener 8.

When the fastener 8 is tightened onto the fitting body, the tang backside surfaces 86 will be advanced forwardly to the position shown in FIG. 7 wherein the flanged rearward ends 80 of the tangs 74 are received within the fastener internal pocket 144. Further in such orientation, the fastener end wall 138 abuttably engages the tang backside surface 86 in a force transmitting communication urging the collet 20, along with the retained pipe end 12, forwardly such that the collet tangs 74, as guided by the tang chamfered surfaces 96 and the body lead-in chamfer 41, are led coaxially along axis 26 into the socket of the body bore rearward end portion 40. Therein, the opening of the collet tangs 74 is constrained by the bore inner circumferential surface 42 which may be sized to have an inner diameter which has a close tolerance with the outer diameter of the collet wall portion 98. The body taper 43, moreover, may provide additional constraint against the opening of the collet tangs 74 as the collet forward portion 70 is continued to be advanced within the socket.

As the make-up of the connection continues, the pipe corrugation 60 is collapsed and compressed between the collet tang surfaces 92 and the body sealing surface 50 into the generally flared configuration shown at 210, thereby effecting a fluid-tight, preferably metal-to-metal, seal between such flare 210 and the body surface 50 and the collet ring 95. As the make-up of the connection proceeds from the insertion of the pipe end 12 to the forming of the flare 210, it may be seen that the pipe outer diameter may be closely supported over two or more, and, typically, four or five or more corrugations, by the inner diameter of the collet 20. Such support assists in guiding the pipe end 12 into the body socket 40, and in ensuring that the pipe 4 is centered relative to the body sealing surface 50, and may obviate the need and expense of forming the fitting body 7 as having a separate sleeve or other structure which must be received within the pipe inner diameter as a guide for leading the pipe into the fitting.

In the illustrated embodiment, the diameter of the body apex 51 may be sized to be incrementally larger than the minor outer diameter of the pipe 4 so as to provide a fold-over point intermediate the major and minor outer diameters of the pipe 12 which initiates the inversion of the pipe corrugation 60 into the flare 210. Moreover, as pipe 4 typically is cut to length with a conventional C-clamp type pipe cutter or the like, the cut end 66 of the pipe could potentially scratch or otherwise damage the surface 50. As such damage could affect the fluid-tight seal between the surface 50 and the flare 210, a more reliable seal may be provided by virtue of the described folding over of the flare. Although it has been described that only the first pipe corrugation is compressed, it will be appreciated that any number of corrugations left projecting beyond the collet may be so compressed and collapsed if the fitting componentry is sized accordingly. To disconnect the primary pipe 4 from the fitting body 7, the connection sequence simply is reversed.

Thus, the above-described fitting connection for the corrugated primary pipe provides for easy and simple assembly, and may be used to achieve a fluid-tight or other secure connection in a single operation.

Secondary Pipe-Fitting Connection

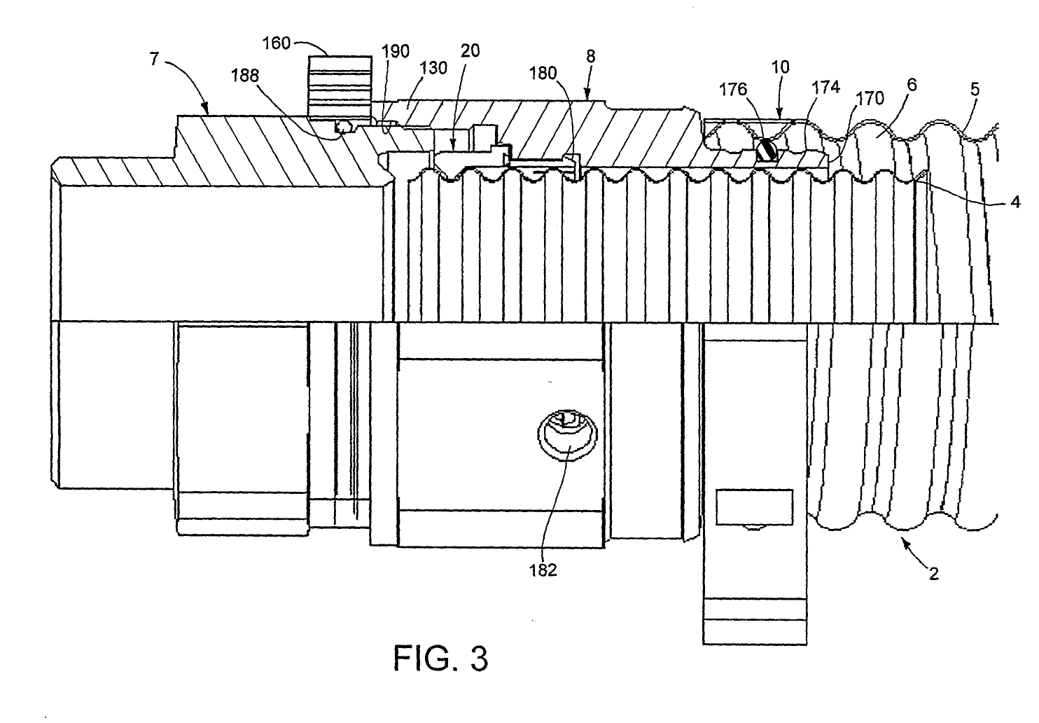

In accordance with a preferred embodiment of the present invention and as illustrated in FIGS. 2 and 3, the fastener 8 has a tubular coupling portion 170 opposite its internally threaded portion 130. The tubular coupling portion 170 is configured to receive an end portion of the outer secondary (containment) pipe 5. The coupling device 10 is provided to secure the end portion of the outer containment pipe in fluid tight relationship to the tubular coupling portion 170 of the fastener. The coupling device may include one or more of a compression fitting, bonded joint, a push-to-connect mechanism, or a clamp.

In the illustrated embodiment, the tubular coupling portion 170 is configured to have the end portion of the outer secondary pipe 5 pushed thereover in a telescopic manner and then fastened in a sealed relationship by a clamp 10. As shown, the outer surface of the tubular coupling portion is formed with axially spaced apart, annular ribs 174 that may have rounded radially outer ends as shown to facilitate engagement with the inner diameter surface of the corrugated secondary pipe. An annular seal 176 is provided to seal the inner diameter of secondary pipe to the outer surface of the tubular portion 170.

The clamp 10 may be of any suitable type. In the illustrated embodiment, a T-bolt band clamp is used, the band thereof being cinched around the secondary pipe. In the several figures, the clamp is shown prior to tightening. When tightened, the clamp will crush the underlying corrugations against the tubular coupling portion and the seal 176 that provides a fluid-tight connection. Other usable clamps are clamshell type clamps and worm gear clamps, for example.

Fastener Access Port

As seen in FIGS. 2 and 3, the fastener 8 when tightened will define with the fitting body and outer surface of the primary pipe 4, an interior space 180 that is in fluid communication with the interstitial space 6 between the primary and secondary pipes. The fastener also has an access port 182 extending from the interior space 180 to the exterior of the fastener. The access port is provided to enable external monitoring of the interstitial space between the primary and secondary pipes.

The access port 182 may be in the form of a view port allowing visual viewing of the interior space from outside the fastener. This may be implemented by providing a sight glass in the view port, such as a transparent or translucent lens in the wall of the fastener for optical enhancement of an interior portion of the interior space. The lens may have outer and inner surfaces, at least one of which is curved to optically magnify the interior space of the cavity. The lens may be secured in an opening in the wall of the fastener or formed during molding of the fastener if the fastener is formed from molded plastic.

The access port 182 may also provide for through access of a sensor for detecting the presences and/or absence of fluid in the interior space, or it may function as a test port providing for connection of a conduit connected to a remotely located sensor. To facilitate connection of a conduit thereto, such as a hose, tube, etc., the port may be threaded. Preferably the portion of the fastener forming the port does not project radially beyond the wrenching surfaces 32 (FIG. 1) provided on the fastener so as not to interfere with tightening (or loosening) of the fastener on the fitting body.

To prevent leakage between the fastener 8 and fitting body 7, a seal 188 is provided. The seal, for example an O-ring, may be carried in an annular groove on the outer diameter surface of the fitting body such that it will be engaged and compressed when the fastener is tightened onto the fitting body. In the illustrated embodiment, the O-ring will seal against a cylindrical interior surface located forwardly of the internal threads of the fastener. The cylindrical surface may transition to a leading beveled surface at the leading end of the fastener.

To provide for increased flow area between the primary and secondary pipes and more particularly between the interstitial space 6 and the interior space 180 at the regions of the radially outwardly disposed annular crests, the crests 62 of the corrugated primary pipe 4 can be dented to form one or more axially extending recesses 192 as illustrated in FIG. 8. Preferably, each crest had formed therein a plurality of the recesses that are annularly spaced apart.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A flexible double wall pipe assembly comprising an inner primary pipe for conveying a fluid and an outer secondary pipe surrounding the primary pipe for containing any fluid leaks from the primary pipe, wherein the inner primary pipe and outer secondary pipe define therebetween an interstitial space extending along the lengths thereof to allow any fluid released from the primary pipe to flow along the length of the interstitial space, and the inner primary pipe is a flexible annularly corrugated pipe having annular valley portions alternating with annular crest portions that define a major outer diameter of the pipe.

2. A double wall pipe assembly according to claim 1, wherein the corrugated pipe is made of stainless steel.

3. A double wall pipe assembly according to claim 1, wherein the secondary pipe is made of a thermoplastic material.

4. A double wall pipe assembly according to claim 1, wherein radially outwardly disposed annular crests of the corrugated pipe have one or more axially extending recesses formed therein for providing increased flow area between the primary and secondary pipes at the regions of the radially outwardly disposed annular crests.

5. A double wall pipe assembly according to claim 4, wherein the radially outwardly disposed annular crests each have a plurality of the recesses formed therein and the recesses are annularly spaced apart.

6. A double wall pipe assembly according to claim 1, in combination with a fitting assembly, the fitting assembly comprising a fitting body having a threaded end portion, a fastener having a threaded portion for threadedly engaging the threaded portion of the fitting body, and a collet which is receivable coaxially within the fastener, wherein the fitting body has a socket for receiving the collet and an annular sealing surface at an inner end of the socket, the collet includes a circumferential arrangement of axially extending segments having sufficient radial flexibility to allow the annular crests of the corrugated pipe to pass axially through the collet for engagement of an end of the corrugated pipe against the sealing surface of the fitting body, and the fastener is engageable with the collet when tightened on the fitting body to urge the collet axially for causing distal ends of the segments to urge a corrugation at the end of the corrugated pipe into sealing engagement with the sealing surface of the fitting body.

7. A pipe and fitting combination according to claim 6, wherein the fastener includes a tubular portion opposite its threaded portion, the tubular portion being configured to receive an end portion of the outer secondary pipe, and there is provided a coupling device for securing the end portion of the outer secondary pipe in fluid tight relationship to the tubular portion of the fastener.

8. A pipe and fitting combination according to claim 7, wherein the coupling device includes one or more of a compression fitting, bonded joint, a push-to-connect mechanism, or a clamp.

9. A pipe and fitting combination according to claim 6, wherein the fastener includes an interior space in fluid communication with the interstitial space between the primary and secondary pipes, and an access port extending from the interior space to the exterior of the fastener.

10. A pipe and fitting combination according to claim 9, wherein the access port is a view port allowing visual viewing of the interior space from outside the fastener.

11. A pipe and fitting combination according to claim 9, wherein the port is threaded.

12. A pipe and fitting combination according to claim 9, wherein the interior space is at least partly defined by the fastener and the fitting body, and a seal is interposed between the fastener and the fitting body to seal the interior space with respect to the outside.

13. A fitting assembly for a flexible double wall pipe assembly that includes an inner primary pipe for conveying a fluid and an outer secondary pipe surrounding the primary pipe with an interstitial space formed between the pipes and extending along the lengths thereof, the fitting assembly comprising a fitting body having a threaded end portion, and a fastener having a threaded portion for threadedly engaging the threaded portion of the fitting body and for securing the primary pipe to the fitting body, and wherein the fastener includes a tubular portion opposite its threaded portion, the tubular portion is configured to receive an end portion of the outer secondary pipe, and there is provided a coupling device for securing the end portion of the outer secondary pipe in fluid tight relationship to the tubular portion of the fastener.

14. A fitting assembly according to claim 13, wherein the coupling device includes one or more of a compression fitting, bonded joint, a push-to-connect mechanism, or a clamp.

15. A fitting assembly according to claim 13, wherein the fastener includes an interior space for fluid communication with the interstitial space between the primary and secondary pipes, and an access port extending from the interior space to the exterior of the fastener.

16. A fitting assembly according to claim 15, wherein the access port is a view port allowing visual viewing of the interior space from outside the fastener.

17. A fitting assembly according to claim 15, wherein the access port is threaded.

18. A fitting assembly according to claim 15, wherein the interior space is at least partly defined by the fastener and the fitting body, and a seal is interposed between the fastener and the fitting body to seal the interior space with respect to the outside.

19. A fitting assembly for a flexible double wall pipe assembly that includes an inner primary pipe for conveying a fluid and an outer secondary pipe surrounding the primary pipe with an interstitial space formed between the pipes and extending along the lengths thereof, the fitting assembly comprising a fitting body, and a fastener for connecting the primary and secondary pipes to the fitting, wherein the fastener includes an access port for connecting to the interstitial space when the primary and secondary pipes are connected to the fitting body by the fastener.
